(19) United States
(12) Patent Application Publication
(10) Pub. No.: US 2026/0058855 A1
(43) Pub. Date: Feb. 26, 2026

(54) SYSTEMS, APPARATUSES, METHODS, AND NON-TRANSITORY COMPUTER-READABLE STORAGE DEVICES FOR WIRELESS COMMUNICATION EMPLOYING 2X-LONG TRAINING FIELDS FOR DISTRIBUTED RESOURCE UNIT TRANSMISSION

(71) Applicant: HUAWEI TECHNOLOGIES CO., LTD., SHENZHEN (CN)

(72) Inventors: Sara NOROUZI, Kanata (CA); Jung Hoon SUH, Kanata (CA); Yan XIN, Kanata (CA); Osama ABOUL-MAGD, Kanata (CA); Mahmoud Ahmed Mohammed HASABELNABY, Kanata (CA)

(73) Assignee: HUAWEI TECHNOLOGIES CO., LTD., SHENZHEN (CN)

(21) Appl. No.: 18/947,835

(22) Filed: Nov. 14, 2024

Related U.S. Application Data
(60) Provisional application No. 63/687,104, filed on Aug. 26, 2024.

(51) Int. Cl. H04L 27/26; H04L 5/00

(52) U.S. Cl. CPC H04L 27/2613; H04L 5/0046; H04L 5/0094

(57) ABSTRACT

A communication method including receiving a packet including a reduced-length long training field (LTF) corresponding to a set of distributed resource units (DRU) tones. The method further includes, based at least in part on a DRU tone plan, performing one or more arithmetic operations on the reduced-length LTF in order to obtain a complete LTF associated with the reduced length LTF. In some embodiments, there is provided a DRU tone plan for 40 MHz DBW. The DRU tone plan includes: eighteen 26-tone DRUs with eighteen tone spacing between the tones; eight 52-tone DRUs, built from two DRU26, with eight or ten tone spacing between the tones; four 106-tone DRUs, built from four DRU26 or two DRU52 and 2 extra padding tones, with four or six tone spacing between the tones; and two 242-tone DRUs, built from two DRU106 and one DRU26 and 4 extra padding tones, with two tone spacing between the tones.

### CROSS-REFERENCE TO RELATED APPLICATIONS

This application claims the benefit of U.S. provisional patent application No. 63/687,104 filed on Aug. 26, 2024, the contents of which are incorporated herein by reference in their entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing 2×-long training fields (LTFs) for distributed resource unit (DRU) transmission.

### BACKGROUND

Wireless communication systems such as IEEE 802.11 series (that is, Wi-Fi® series; Wi-Fi is a registered trademark of Wi-Fi Alliance, Austin, TX, USA) are known. In recent IEEE 802.11 series, the distributed resource unit (DRU) transmission has been introduced in the ultra-high reliability (UHR) system for a trigger-based (TB) physical layer protocol data unit (PPDU). The long training field (LTF) has been only occupied to the subcarriers overlapped with the scheduled resource unit (RU), and the same principle may continue to be applied to the DRU as well.

However, in prior art, the DRU tone plans do not include any LTF arrangement, and there is no LTF arrangement in the application of DRU in a TB PPDU transmission. Moreover, the 2×-LTF sequence may not be assigned to the tones where the DRU is scheduled. Consequently, it may not be possible to apply the 2×-LTF sequence as it is defined in the high efficiency (HE) or extremely high throughput (EHT) systems.

Therefore, there is a need for a method, apparatus and system for wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method, system and apparatus for wireless communication employing 2×-long training fields (LTF) for distributed resource unit (DRU) transmission.

According to an aspect of the present disclosure, there is provided a communication method. The method includes receiving a packet including a reduced-length long training field (LTF) corresponding to a set of distributed resource units (DRU) tones. The method further includes, based at least in part on a DRU tone plan, performing one or more arithmetic operations on the reduced-length LTF in order to obtain a complete LTF associated with the reduced length LTF.

In some embodiments, performing one or more arithmetic operations on the reduced-length LTF results in obtaining one or more amended reduced-length LTF.

In some embodiments, the method further includes appending the one or more amended reduced-length LTF to the reduced-length LTF to obtain a complete LFT associated with the reduced-length LTF.

According to an embodiment, there is provided a DRU tone plan for 40 MHz DRU Bandwidth (DBW). The DRU tone plan includes: eighteen 26-tone DRUs with eighteen tone spacing between the tones; eight 52-tone DRUs, built from two DRU26, with eight or ten tone spacing between the tones; four 106-tone DRUs, built from four DRU26 or two DRU52 and 2 extra padding tones, with four or six tone spacing between the tones; and two 242-tone DRUs, built from two DRU106 and one DRU26 and 4 extra padding tones, with two tone spacing between the tones.

According to an embodiment, there is provided a DRU tone plan for 20 MHz DBW. The DRU tone plan includes: one 26-tone DRU (DRU5) with one or seventeen tone spacing between the tones; eight 26-tone DRUs with eight or ten tone spacing between the tones; four 52-tone DRUs built from two DRU26, with four or six tone spacing between the tones; and two 106-tone DRUs built from two DRU52 and 2 extra padding tones, with two or four tone spacing between the tones.

According to an embodiment, there is provided another DRU tone plan for 20 MHz DBW. The DRU tone plan includes: one 26-tone DRU (DRU5) with one or seventeen tone spacing between the tones; eight 26-tone DRUs with eight or ten tone spacing between the tones; four 52-tone DRUs, is built from two DRU26, with four or six tone spacing between the tones; and two 106-tone DRUs, built from two DRU52 and 2 extra padding tones. The 106-tone DRU1 has two and four tone spacing everywhere, while the 106-tone DRU2 has one or five tone spacing around DC tones and two or four tone spacing everywhere else.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus including: one or more processors functionally connected to one or more memories for performing the above-described methods.

According to one aspect of this disclosure, there is provided one or more non-transitory computer-readable storage devices including computer-executable instructions, wherein the instructions, when executed, cause one or more circuits to perform the above-described methods.

According to one aspect of this disclosure, there is provided an apparatus configured to perform any one of the above mentioned methods and their embodiments. Specifically, the apparatus includes one or more units configured to perform any one of the above mentioned methods and their embodiments.

According to one aspect of this disclosure, there is provided a computer-readable storage medium. The computer-readable storage medium stores a computer program, and when the computer program is executed by an apparatus, the apparatus is enabled to implement any one of the above mentioned methods and their embodiments.

According to one aspect of this disclosure, there is provided a computer program product including one or more instructions. When the instructions are executed by an apparatus such as a computer, the apparatus is enabled to implement any one of the above mentioned methods and their embodiments.

According to one aspect of this disclosure, there is provided a computer program. When the computer program is executed by a computer, an apparatus is enabled to implement any one of above mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 is a simplified schematic diagram showing a communication system, according to some embodiments of this disclosure.

FIG. 2 is a simplified schematic diagram of an access point (AP) of the communication network of the communication system shown in FIG. 1.

FIG. 3 is a simplified schematic diagram of a station (STA) of the communication system shown in FIG. 1.

FIG. 4 is a schematic diagram showing a tone plan example for 20 MHz.

FIG. 5 is a schematic diagram showing a tone plan example for 40 MHz.

FIG. 6 is a schematic diagram showing a tone plan example for 80 MHz.

FIG. 7 is a schematic diagram showing a DRU tone plan example for 40 MHz.

FIG. 8A is a schematic diagram showing a tone plan for 40 MHz, according to embodiments of the present disclosure.

FIG. 8B is a schematic diagram showing a logical RU index for 40 MHz in the time domain, according to embodiments of the present disclosure.

FIG. 9A is a graph showing the first half of 26-tone DRUs for a 40 MHz plan in the time domain, according to embodiments of the present disclosure.

FIG. 9B is a graph showing the second half (repetition) of 26-tone DRUs for a 40 MHz plan, according to embodiments of the present disclosure.

FIG. 9C is a schematic diagram showing a difference between FIGS. 9A and 9B, according to embodiments of the present disclosure.

FIG. 10A is a graph showing the first half of 52-tone DRUs for a 40 MHz plan in the time domain, according to embodiments of the present disclosure.

FIG. 10B is a graph showing the second half (repetition) of 52-tone DRUs for a 40 MHz plan, according to embodiments of the present disclosure.

FIG. 10C is a schematic diagram showing a difference between FIGS. 10A and 10B, according to embodiments of the present disclosure.

FIG. 11A is a graph showing the first half of 106-tone DRUs for a 40 MHz plan in the time domain, according to embodiments of the present disclosure.

FIG. 11B is a graph showing the second half (repetition) of 106-tone DRUs for a 40 MHz plan, according to embodiments of the present disclosure.

FIG. 11C is a schematic diagram showing a difference between FIGS. 11A and 11B, according to embodiments of the present disclosure.

FIG. 12A is a graph showing the first half of 242-tone DRUs for a 40 MHz plan in the time domain, according to embodiments of the present disclosure.

FIG. 12B is a graph showing the second half (repetition) of 242-tone DRUs for a 40 MHz plan, according to embodiments of the present disclosure.

FIG. 12C is a schematic diagram showing a difference between FIGS. 12A and 12B, according to embodiments of the present disclosure.

FIG. 13 is a schematic diagram showing a DRU tone plan example for 20 MHz of the present disclosure.

FIG. 14 is a schematic diagram showing a tone plan for 20 MHz, according to embodiments of the present disclosure.

FIG. 15 is a graph showing the whole signal for LTF in the time domain, 26-tone DRU1 (real and imaginary) for 20 MHz, according to embodiments of the present disclosure.

FIG. 16 is a graph showing the first half of the signal for LTF in the time domain, 26-tone DRU1 (real and imaginary) for 20 MHz, according to embodiments of the present disclosure.

FIG. 17 is a schematic diagram showing another tone plan for 20 MHz, according to embodiments of the present disclosure.

FIG. 18 illustrates a method according to embodiments of the present disclosure.

It will be noted that throughout the appended drawings, like features are identified by like reference numerals.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) ultra high reliability (UHR) systems (for example, IEEE 802.11 bn or WI-FI® 8 systems), 5G or 6G wireless mobile communication systems, and the like.

### A. System Structure

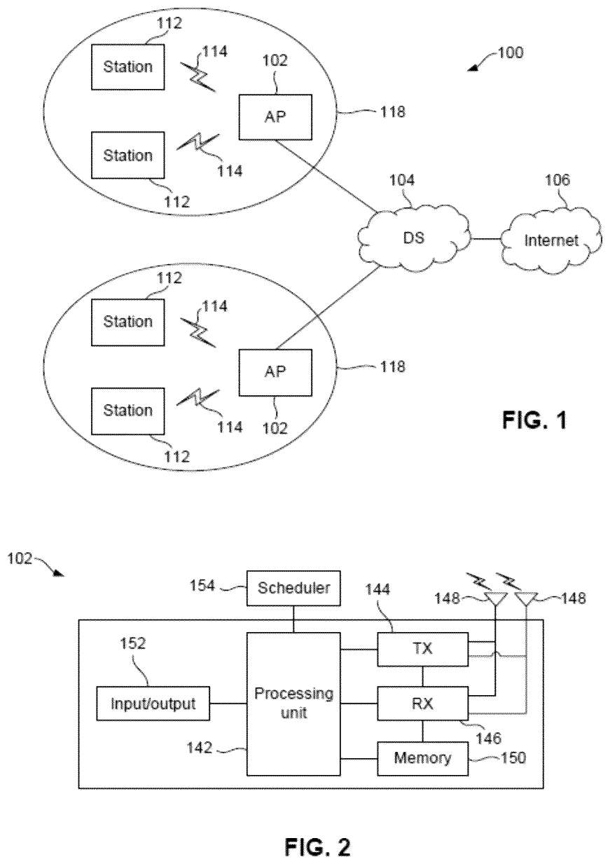

Turning now to FIG. 1, a communication system according to some embodiments of this disclosure is shown and is generally identified using reference numeral 100. As an example, the communication system 100 may be a Wi-Fi® system built under relevant standards such as IEEE 802.11 standard. As shown, the communication system 100 includes a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet protocol (IP), transmission control protocol (TCP), user datagram protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 includes at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

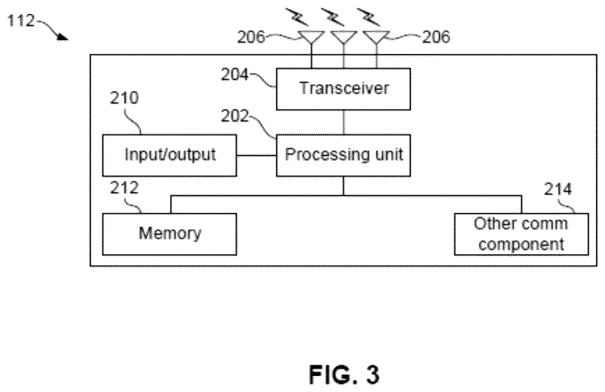

FIG. 3 is a simplified schematic diagram of a STA 112. As shown, the STA 112 includes at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL© microprocessor (INTEL is a registered trademark of Intel Corp., Santa Clara, CA, USA), an AMD© microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality of orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Long Training Fields (LTFs) for Distributed Resource Unit (Dru) Transmission

The 2×-LTF feature was introduced in 802.11 ax to reduce the LTF overhead by one half compared to 4×-LTF, while performance degradation was limited in certain channel environments. Herein, “2×-LTF” means the symbol length is two (2) times of the symbol length of IEEE 802.11n/ac OFDM symbol, such as four (4) microseconds (psec) including the guard interval. Similarly, “4×-LTF” means the symbol length is four (4) times of the symbol length of IEEE 802.11n/ac OFDM symbol. The long training sequence (LTS) of 2×-LTF occupies every other tone among the subcarriers that the 4×-LTF sequence occupies, and the tones which are not occupied by the 2×-LTF sequence are left blank with no energy, which creates the repeated samples in the time domain after taking an inverse discrete Fourier transform (IDFT) of 2×-LTF. Those repeated samples in the time domain are delineated into two repeating units in the middle of the OFDM symbol and only one repeating unit is transmitted, which reduces the LTF symbol length by one half. The following is the 2×-LTF sequence defined in 11ax in a 20 MHz transmission.

For subcarrier index range [−122:122], LTF used in HE system, that is, HELTF_{-122,122} is:

$${HELTF}_{- 122 , 122} = \{ + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , - 1 , 0 , - 1 , 0 , + 1 , 0 , + 1 , 0 , - 1 , 0 , + 1 , 0 , + 1 , 0 , + 1 , 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , - 1 , 0 , - 1 , 0 , + 1 , 0 , + 1 , 0 , + 1 , 0 , - 1 , 0 , - 1 , 0 , + 1 , 0 , 0 , 0 , + 1 , 0 , - 1 , 0 , + 1 , 0 , + 1 , 0 , - 1 , 0 , + 1 , 0 , + 1 , 0 , - 1 , 0 , + 1 , 0 , + 1 , 0 , - 1 , 0 , - 1 , 0 , + 1 , 0 , - 1 , 0 , + 1 , 0 , + 1 , 0 , + 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , + 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , + 1 \}$$

As we see from the 2×-LTF sequence defined in IEEE 802.11ax, there is a zero between two non-zero sequences, which generates the repeated samples in the time domain after being taken with IDFT operation.

The DRU transmission takes the best advantage of TX Power boosting gain in an OFDMA-based TB PPDU in the 6 GHz low power indoor (LPI) band where the DRU tones occupying the entire bandwidth can fully maximize the power spectral density (PSD) requirements set each one (1) megahertz (MHz), however, the 2×-LTF sequence is not aligned with the DRU tone plan, that is, those tones the LTS of 2×-LTF occupies are not aligned with those tones the DRU tone plan occupies.

It is considered that the 4×-LTF sequence occupies only the tones corresponding to the DRU tone plan in an OFDMA TB PPDU, just like the 4×-LTF sequence applies to the regular resource unit (RRU) in the 11ax or 11be.

We observed the repetition pattern in the time-domain samples of 4×-LTF sequence corresponding to the several DRUs in 80 MHz bandwidth. We can only transmit the first half samples of 4×-LTF corresponding to the DRU which has the repetition pattern in the time-domain samples, which can be the 2×-LTF transmission. That is, we do not have to define a separate 2×-LTF sequence, but only cut in a half of time-domain samples and transmit, when the 4×-LTF sequence is applied to the DRU and generates the repeated time-domain samples.

The method disclosed herein may be targeted for a TB PPDU transmission in a 6 GHz LPI band, and may be used in Wi-Fi® 8 AP and/or STA devices, and/or other future Wi-Fi® AP and/or STA devices.

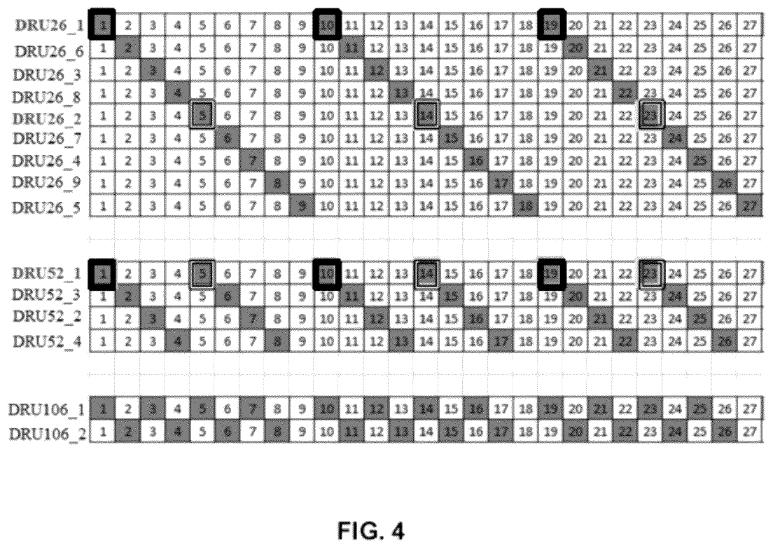

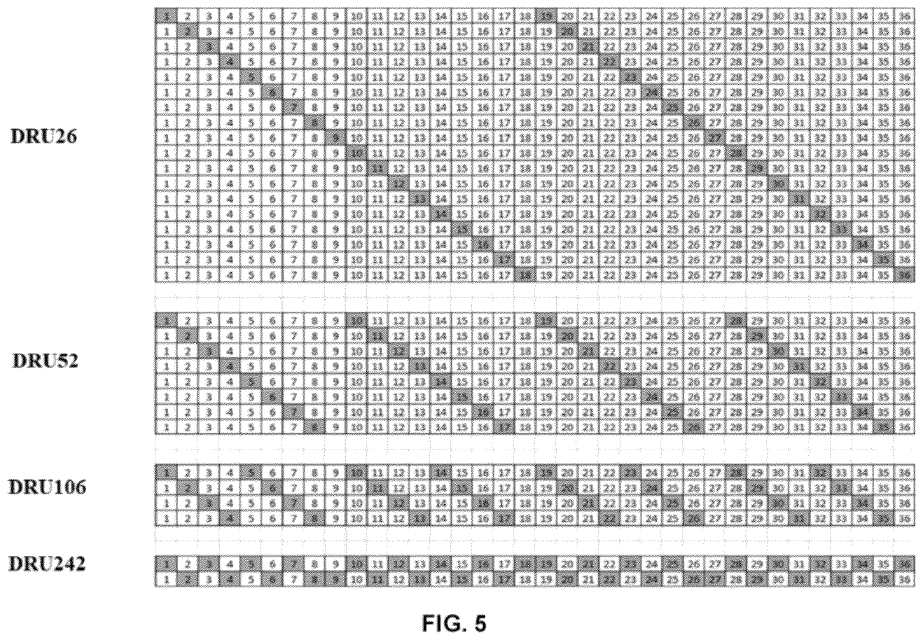

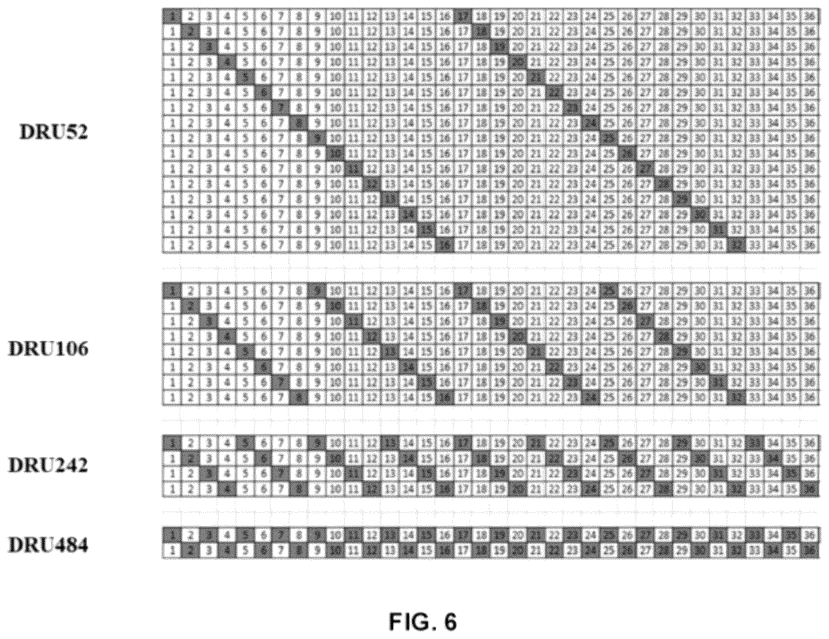

As explained above, the 2×-LTF sequence cannot be applied to the DRU tone plan, since the 2×-LTF sequence is not always aligned with the DRU tone. However, the repetition patterns are observed when the 4×-LTF sequence is assigned to a certain DRU tone plans. Hence, the DRU tone plan is important in determining the repetition in the time-domain samples. Let us introduce the example DRU tone plan according to “DRU Tone Plan for 11bn”, IEEE 802.11-24/468r2, by S. Hu, et. al.
Tone Plan for 20 MHz
   According to “DRU Tone Plan for 11bn”, there are nine 26-tone DRUs, four 52-tone DRUs, and two 106-tone DRUs in the DRU Bandwidth (DBW) 20 MHz where the tone spacing is uniformly or quasi-uniformly distributed, that is, there is nine-tone spacing between the tones in 26-tone DRUs, four- or five-tone spacing between the tones in 52-tone DRUs, and two- or three-tone spacing between the tones in 106-tone DRUs; see FIG. 4.
Tone Plan for 40 MHz
   According to “DRU Tone Plan for 11bn”, there are eighteen 26-tone DRUs, eight 52-tone DRUs, four 106-tone DRUs and two 242-tone DRUs in the DRU bandwidth (DBW) 40 MHz where the tone spacing is uniformly or quasi-uniformly distributed, that is, there is eighteen-tone spacing between the tones in 26-tone DRUs, nine-tone spacing between the tones in 52-tone DRUs, three- or four-tone spacing between the tones in 106-tone DRUs and 1˜3-tone spacing between the tones in 242-tone DRUs; see FIG. 5.
Tone Plan for 80 MHz
   According to “DRU Tone Plan for 11bn”, there are sixteen 52-tone DRUs, eight 106-tone DRUs, four 242-tone DRUs and two 484-tone DRUs in the DRU bandwidth (DBW) 80 MHz where the tone spacing is uniformly or quasi-uniformly distributed, that is, there is sixteen-tone spacing between the tones in 52-tone DRUs, eight-tone spacing between the tones in 106-tone DRUs, four-tone spacing between the tones in 242-tone DRUs and two-tone spacing between the tones in 484-tone DRUs; see FIG. 6.

As seen from FIGS. 4 to 6, some tones of DRUs are not aligned with the non-zero 2×-LTF sequence.

Hence, in some embodiments, the 4×-LTF sequences may be applied to the DRU tones even when transmission using 2×-LTF symbols is needed.

The IDFT operation of an LTF where the 4×-LTF sequences are only occupied at the same tones as the data DRU tones in 80 MHz with the rest unoccupied creates the repeated samples. For example, the 1024-point IDFT operation of 4×-LTF sequence assigned on the tones overlapped with the any DRU106 or DRU242 data tones in 80 MHz as seen on FIG. 6 creates two reverse repeated samples according to a certain 4×-LTF sequences, that is, the time-domain samples with the first sample through the 512th sample after the IDFT operation are repeated with the 513th sample through the 1024th sample after only negating the samples from the 513th sample to the 1024th sample.

For the 2×-LTF symbol transmission, those repeated samples in the time domain after the IDFT of the LTF symbol may be cut in half and transmit, which may reduce the LTF symbol size to one half.

At the RX side, the received 2×-LTF symbol is appended with the same received 2×-LTF symbol or with the modified received 2×-LTF symbol (we need to negate or we need additional arithmetic operation in case the repetition only takes place after the additional arithmetic operation such as a complex conjugate operation is applied to the appended samples), and then discrete Fourier transform (DFT) may be applied to the received samples before the channel estimation. If any smoothing is necessary to recover the entire channel parameters over the entire BW, it can be applied in the frequency domain after taking the DFT

The repetition analysis for some DRU tone plans is as follows.
52/106/242/484-tone DRU in 80 MHz have repetitions and the 2×-LTF-based TB PPDU may be applied.

In some of the above embodiments, the 4×-LTF sequence is applied only to subcarriers corresponding to the non-zero DRU tones, even when transmitting the 2×-LTF based frame is needed, which gives rise to LTF overhead reduction.

In some of the above embodiments, for the 2×-LTF symbol transmission, those repeated samples in the time domain after the IDFT of the LTF symbol are cut in half and transmit, which may reduce the LTF symbol size to one half. Accordingly, 2×-LTF transmission is made possible for the DRU-based TB PPDU.

In some of the above embodiments, the 4×-LTF sequences are occupied at the same tones as the data DRU tones with the rest unoccupied in order to apply the 2×-LTF transmission, allowing application of the LTF sequences for the 2×-LTF-based TB PPDU transmission.

In principle, any OFDM symbol with a certain pattern of repetitions in the time domain can be truncated and transmitted, that is, in case an OFDM symbol creates 4 repetitions (that is, four repeated set of samples) in the time domain, it may transmit only the first repeated set of samples or the first half (which can correspond to the first and the second repeated samples) set of samples out of the 4 repeated set of samples in the time domain. The RX side may need to append the received signal received over the truncated symbol length according to the truncation ratio in the TX side, for example, a quarter or a half symbol length of an OFDM symbol, that is, the truncation ratio determines how many times the RX may need to append the received signal received over the truncated symbol length. This truncation ratio can be indicated in a common field or a special user info field of a trigger frame.

### C. General for DRU Tone Plan

According to embodiments, with even DRU tone spacing, multiple sample repetition in the time domain after applying an inverse discrete Fourier transform (IDFT) can be produced. As previously discussed, a truncated portion of a complete signal can be transmitted, wherein the truncated portion can be a first sample repetition or sample. Upon receipt the truncated portion by the receiver, based on the known DRU tone plan, the complete signal can be recreated by the application of one or more arithmetic operations on the received truncated portion. The arithmetic operations can include one or more of same repetition, mirror repetition, negation, conjugation or other suitable arithmetic operation as would be readily understood. In this manner, the entire signal can be recreated at the receiver without the need for the transmission of the complete signal due to the sample repetition.

According to embodiments, there is provided a communication method including receiving a packet including a reduced-length long training field (LTF) (e.g. the truncated portion or first sample repetition) corresponding to a set of distributed resource units (DRU) tones. The method further includes, based at least in part on a DRU tone plan, performing one or more arithmetic operations on the reduced-length LTF (e.g. the truncated portion or first sample repetition) in order to obtain a complete LTF associated with the reduced length LTF.

As would be understood, the arithmetic operations are performed on the received truncated portion, resulting in an amended received truncated portion. The amended received truncated portion is appended to the received truncated portion thereby at least in part recreating the complete signal at the receiver. Same repetition indicates that the amended received truncated portion is the same as the received truncated portion. It will be readily understood that the appending of an amended received truncated portion can be performed multiple times in order to obtain the complete signal at the receiver. The particular number of times that appending is performed can be defined by the level of truncation of the complete signal at the transmitter. For example, if the truncated portion repeats four times in the complete signal, appending an amended received truncated signal will occur three times in order to obtain the complete signal at the receiver.

According to embodiments, the one or more arithmetic operations can be further defined. Mirror repetition indicates that the amended received truncated portion is a mirror image of the received truncated portion. Negation indicates that the amended received truncated portion is the opposite of the received truncated portion. Conjugation indicates that the amended received truncated portion is the conjugate of the received truncated portion. As previously discussed, one or more other arithmetic operations may be applied in order to determine or evaluate an amended truncated portion.

According to embodiments, there is provided a new DRU tone plan for 40 MHz distribution bandwidth (DBW) in which 2×-LTF and 1×-LTF are applicable. According to embodiments, there is provided two new DRU tone plans for 20 MHz distribution bandwidth (DBW) in which 2×-LTF and 1×-LTF are applicable. These DRU tone plans are discussed in further detail elsewhere herein.

### D. DRU Tone Plan for 40 Mhz BW—2×-LTF Applicable

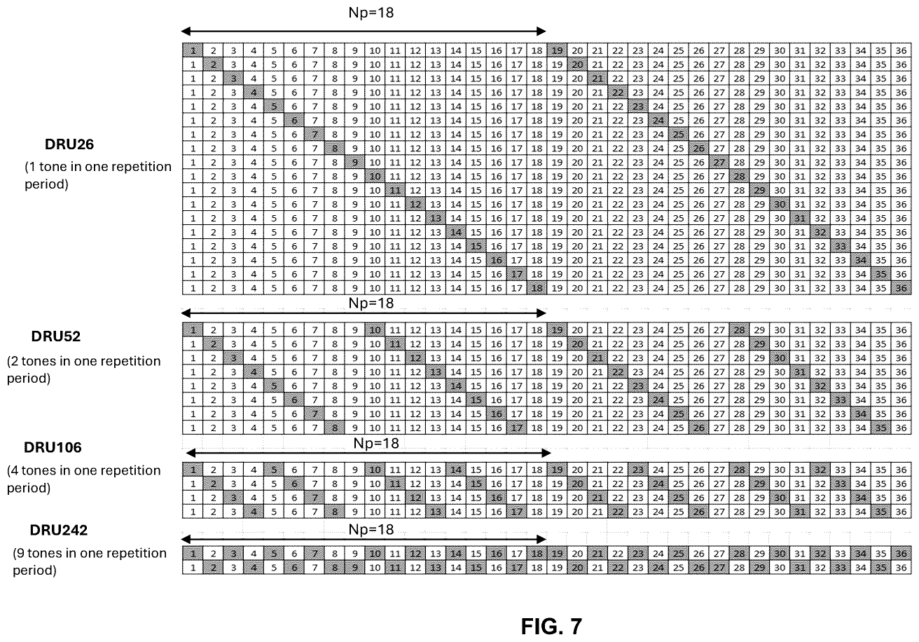

FIG. 7 is a schematic diagram showing a DRU tone plan example for 40 MHz. For this tone plan there are eighteen 26-tone DRUs, eight 52-tone DRUs, four 106-tone DRUs and two 242-tone DRUs in the DRU bandwidth (DBW) 40 MHz where the tone spacing is uniformly or quasi-uniformly distributed, that is, there is eighteen-tone spacing between the tones in 26-tone DRUs, nine-tone spacing between the tones in 52-tone DRUs, three- or four-tone spacing between the tones in 106-tone DRUs and 1˜3-tone spacing between the tones in 242-tone DRUs.

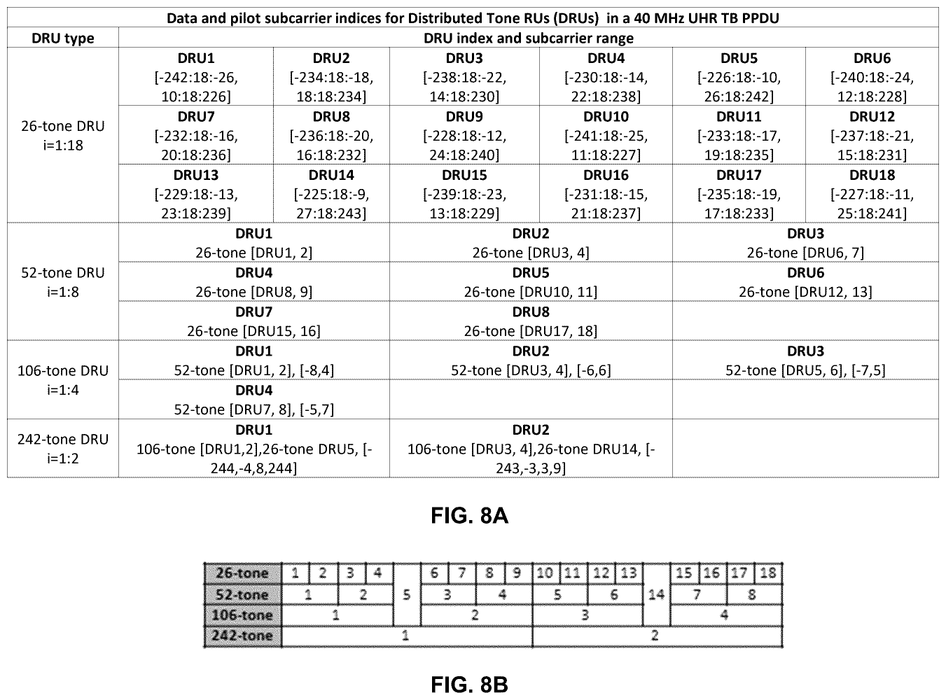

According to embodiments, there is provided a DRU tone plan for 40 MHz BW in which the tone spacing is even for all DRUs of different sizes and hence 2×-LTF is applicable. FIG. 8A is a schematic diagram showing a tone plan for 40 MHz distribution bandwidth (DBW), according to embodiments.

The tone plan illustrated in FIG. 8A includes the following: eighteen 26-tone DRUs with eighteen tone spacing between the tones; eight 52-tone DRUs, built from two DRU26, with eight or ten tone spacing between the tones; four 106-tone DRUs, is built from four DRU26 or two DRU52 and 2 extra padding tones, with four or six tone spacing between the tones; and two 242-tone DRUs, built from two DRU106 and one DRU26 and 4 extra padding tones, with two tone spacing between the tones.

As can be seen from FIG. 8A, 26-tone DRUs and 242-tone DRUs have a uniform distribution pattern. However, 52-tone DRUs and 106-tone DRUs have a near-uniform tone distribution pattern.

In this tone plan, the hierarchical structure as regular resource units (RRU) is preserved. This is illustrated in FIG. 8B which is a schematic diagram showing a logical RU index for 40 MHz in the frequency domain, according to embodiments.

According to embodiments, upon performance of a repetition analysis, it has been determined that all of the 26-tone DRUs, 52-tone DRUs, 106-tone DRUs and 242-tone DRUs in 40 MHz DBW show repetitions in the time-domain which confirms that the 2×-LTF can be applied.

A repetition analysis for the DRU tone plan is provided in the following figures as they relate to 26-tone DRUs for a 40 MHz DBW, 52-tone DRUs for a 40 MHz DBW, 106-tone DRUs for a 40 MHz DBW and 242-tone DRUs for a 40 MHz DBW.

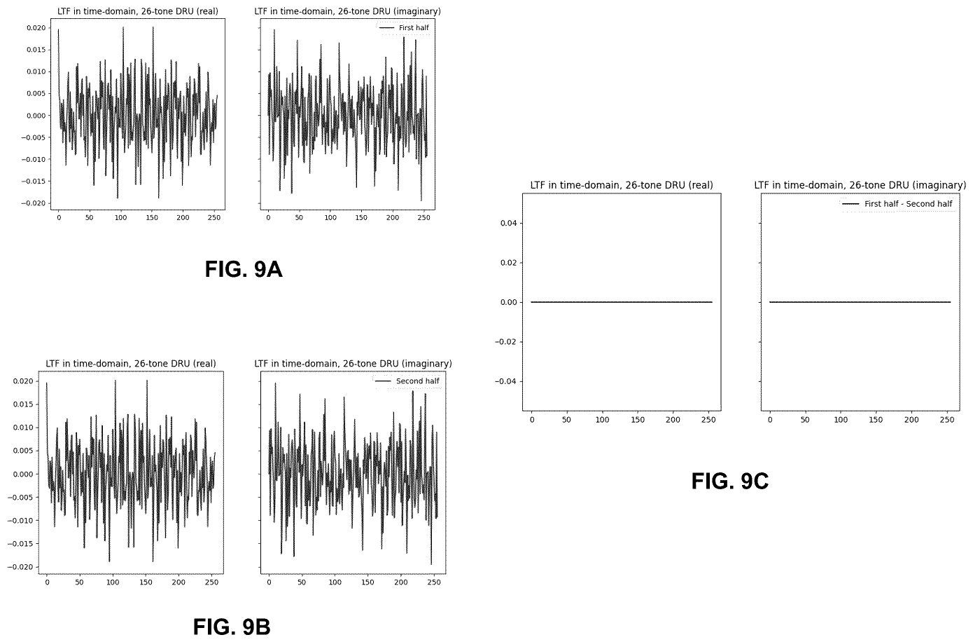

FIG. 9A is a graph showing the first half of 26-tone DRU1 for a 40 MHz DBW plan in the time domain, according to embodiments. FIG. 9B is a graph showing the second half (repetition) of 26-tone DRU1 for a 40 MHz plan, according to embodiments. FIG. 9C is a schematic diagram showing a difference between FIGS. 9A and 9B, which clearly shows that there is equality when using the repetitions. As can be seen, 26-tone DRUs in 40 MHz show repetitions in the time-domain which confirms that the 2×-LTF can be applied.

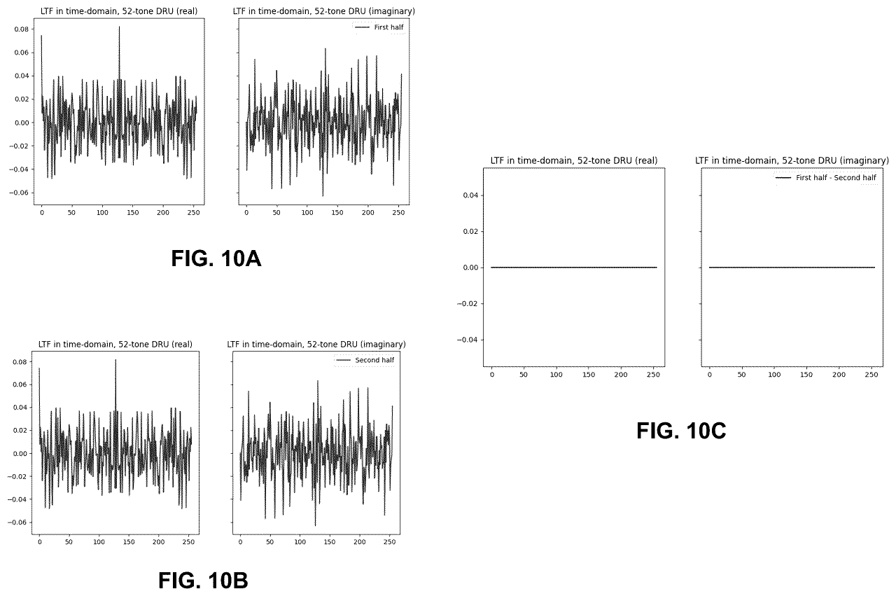

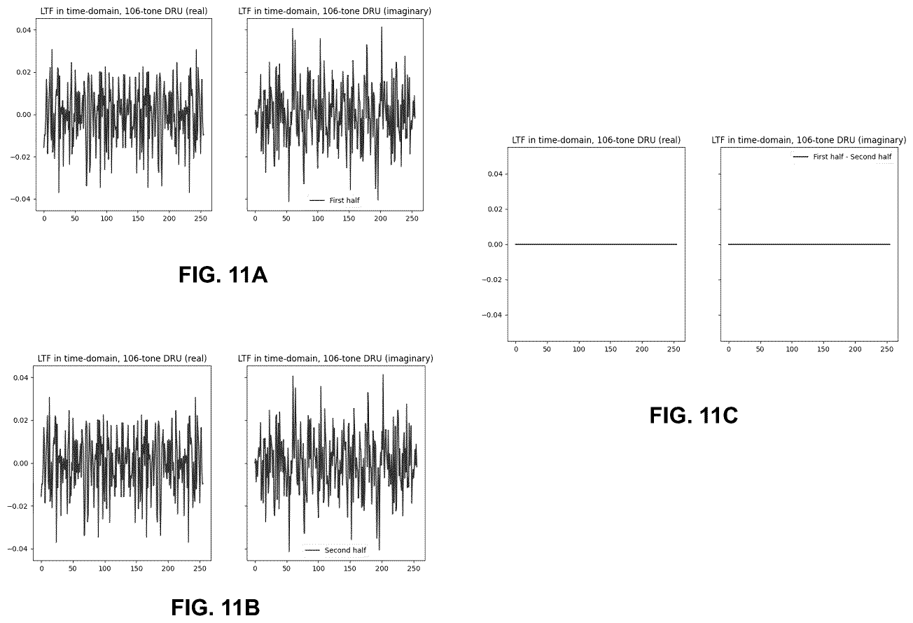

FIG. 10A is a graph showing the first half of 52-tone DRU1 for a 40 MHz plan in the time domain, according to embodiments. FIG. 10B is a graph showing the second half (repetition) of 52-tone DRU1 for a 40 MHz plan, according to embodiments. FIG. 10C is a schematic diagram showing a difference between FIGS. 10A and 10B, which clearly shows that there is equality when using the repetitions. As can be seen, 52-tone DRUs in 40 MHz show repetitions in time-domain which confirms that the 2×-LTF can be applied.

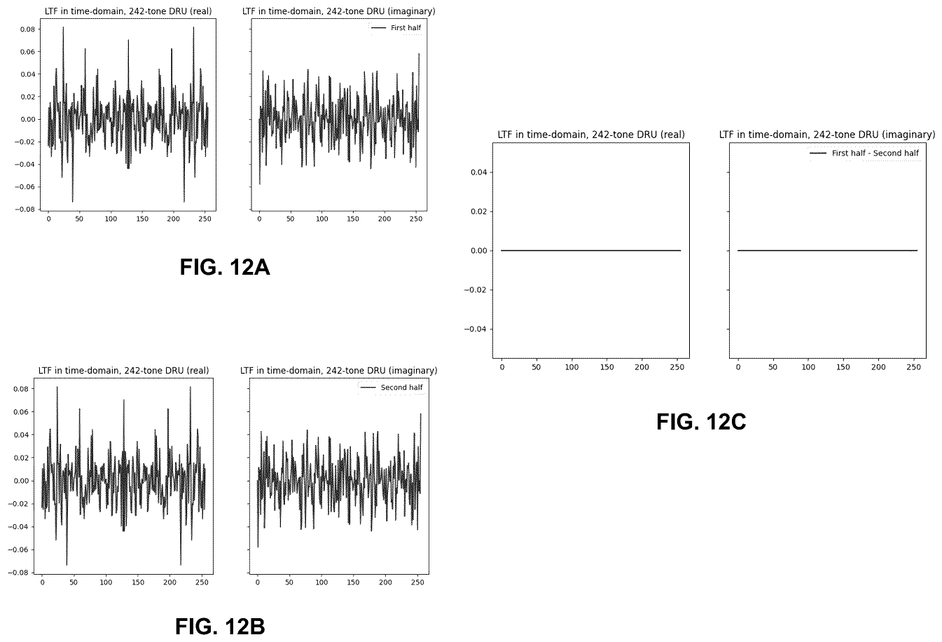

FIG. 11A is a graph showing the first half of 106-tone DRU1 for a 40 MHz plan in the time domain, according to embodiments. FIG. 11B is a graph showing the second half (repetition) of 106-tone DRU1 for a 40 MHz plan, according to embodiments. FIG. 11C is a schematic diagram showing a difference between FIGS. 11A and 11B, which clearly shows that there is equality when using the repetitions. As can be seen, 106-tone DRUs in 40 MHz show repetitions in time-domain which confirms that the 2×-LTF can be applied.

FIG. 12A is a graph showing the first half of 242-tone DRU1 for a 40 MHz plan in the time domain, according to embodiments. FIG. 12B is a graph showing the second half (repetition) of 242-tone DRU1 for a 40 MHz plan, according to embodiments. FIG. 12C is a schematic diagram showing a difference between FIGS. 12A and 12B, which clearly shows that there is equality when using the repetitions. As can be seen, 242-tone DRUs in 40 MHz show repetitions in time-domain which confirms that the 2×-LTF can be applied.

Based on the above repetition analysis for the DRU tone plan defined in FIG. 8A, it can also be seen in that the second quarter of the symbol is the mirrored and conjugated version of the first quarter.

It should be noted that this repetition pattern of LTF in the time-domain shown in FIGS. 9A&B, 10A&B, 11A&B and 12A&B verifies that even 1×-LTF is possible with respect to the tone plan defined in FIG. 8A. According to embodiments, for 1×-LTF, a quarter of the symbol can be transmitted and the rest of the symbol can be reconstructed at the receiver side using any arithmetic operations including same repetition, mirror, negation, conjugate or other suitable arithmetic operation as would be readily understood.

### E. DRU Tone Plan for 20 Mhz BW—2×-LTF Applicable

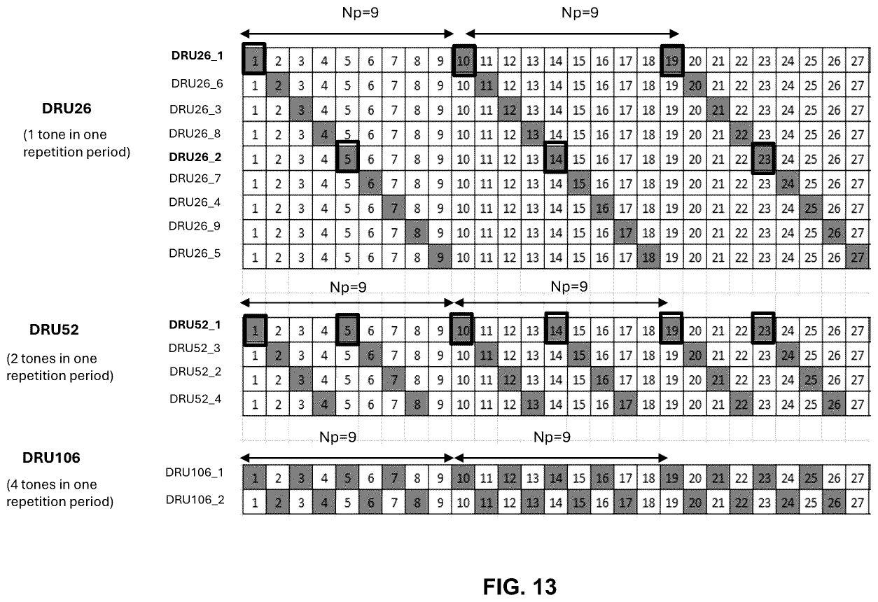

FIG. 13 is a schematic diagram showing a DRU tone plan example for 20 MHz. For this tone plan there are there are nine 26-tone DRUs, four 52-tone DRUs, and two 106-tone DRUs in the DRU Bandwidth (DBW) 20 MHz where the tone spacing is uniformly or quasi-uniformly distributed, that is, there is nine-tone spacing between the tones in 26-tone DRUs, four- or five-tone spacing between the tones in 52-tone DRUs, and two- or three-tone spacing between the tones in 106-tone DRUs; see FIG. 4.

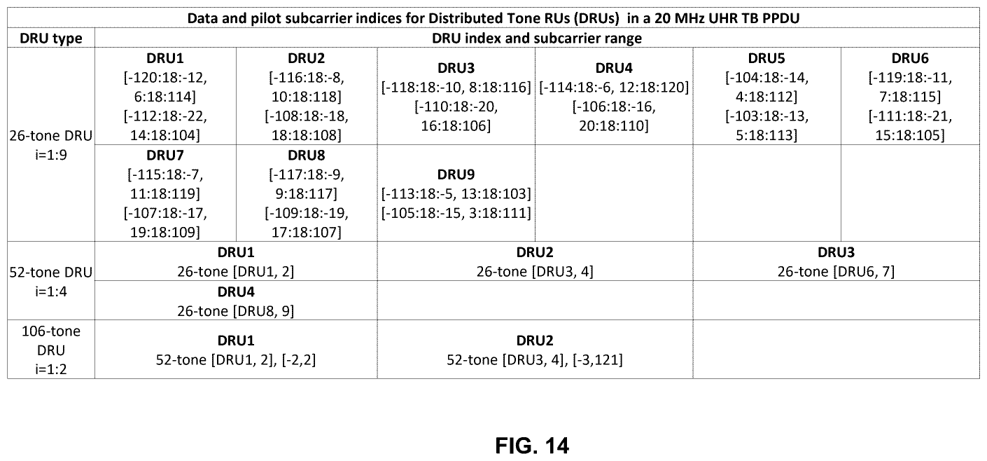

According to embodiments, there is provided a DRU tone plan for 20 MHz BW in which 2×-LTF and 1×-LTF are applicable. FIG. 14 is a schematic diagram showing a tone plan for 20 MHz distribution bandwidth (DBW), according to embodiments. It is noted that to produce sample repetition in the time domain after IDFT, even tone spacing is needed. However, in this case the DRUs are rearranged to have even tone spacing while sacrificing 26-tone DRU5 in which tone spacing is odd.

The tone plan illustrated in FIG. 14 includes the following: one 26-tone DRU (DRU5) with one or seventeen tone spacing between the tones; eight 26-tone DRUs with eight or ten tone spacing between the tones; four 52-tone DRUs, is built from two DRU26, with four or six tone spacing between the tones; and two 106-tone DRUs, built from two DRU52 and 2 extra padding tones, with two or four tone spacing between the tones. It is to be noted that in this tone plan, hierarchical structure as RRU is preserved.

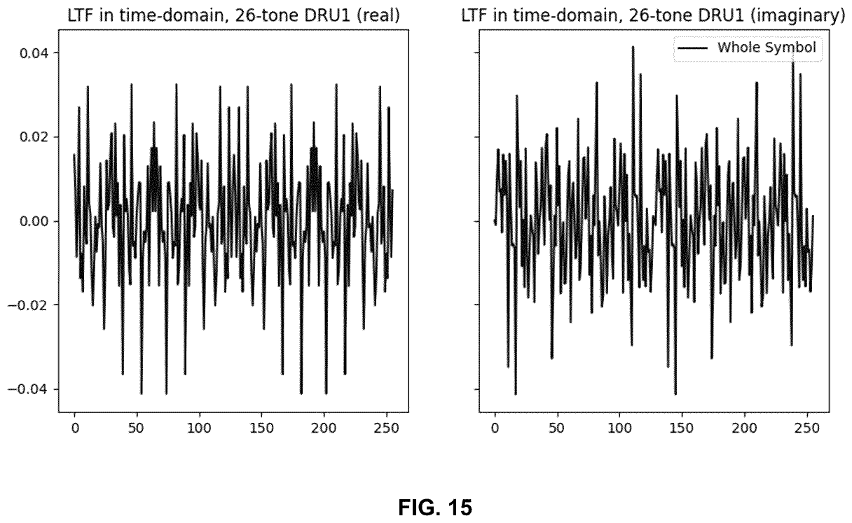

FIG. 15 is a graph showing the whole signal for LTF in time domain, 26-tone DRU1 (real and imaginary) for 20 MHz, according to embodiments.

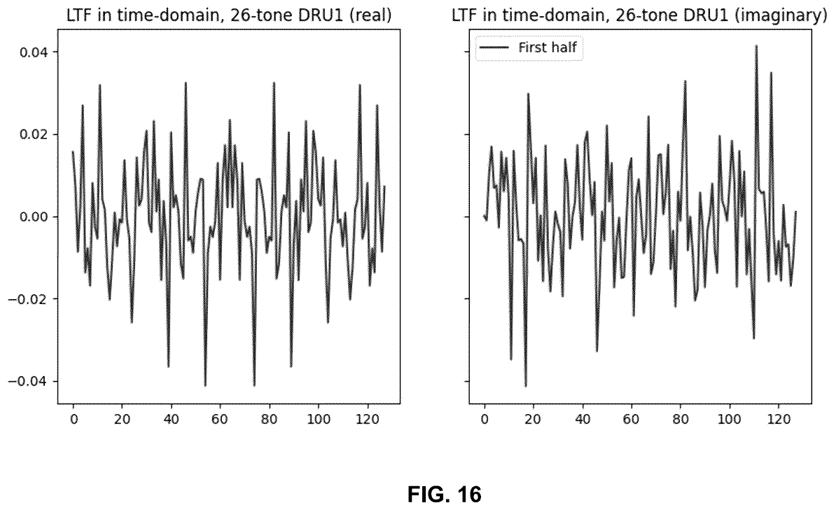

FIG. 16 is a graph showing the first half of the signal for LTF in time domain, 26-tone DRU1 (real and imaginary) for 20 MHz, according to embodiments.

Based on a repetition analysis for this DRU tone plan for 20 MHz DBW of the instant application, 26-tone DRUs, 52-tone DRUs and 106-tone DRUs in 20 MHz show repetitions in the time-domain which confirms that the 2×-LTF can be applied with the exception of the 26-tone DRU5. In addition, also based on this repetition analysis, it can be noted that using the DRU tone plan for 20 MHz DBW of the instant application, 1×-LTF is possible, with the exception of the 26-tone DRU5.

### F. Another DRU Tone Plan for 20 Mhz BW—2×-LTF Applicable

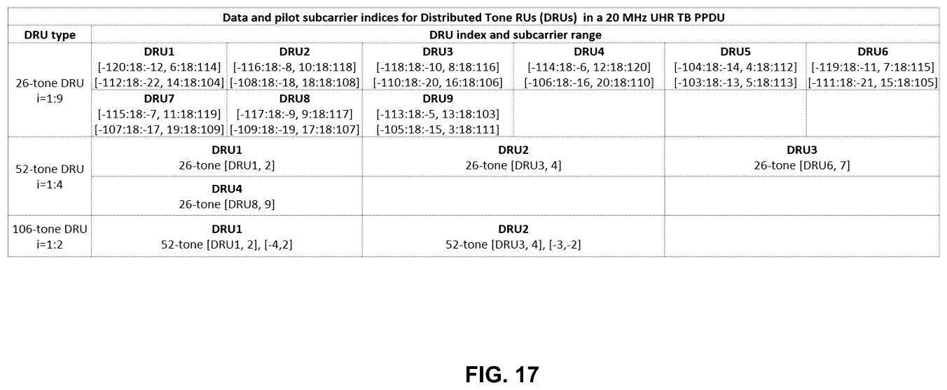

According to embodiments, there is provided a second approach for a DRU tone plan for 20 MHz BW in which 2×-LTF and 1×-LTF are applicable. FIG. 17 is a schematic diagram showing this second approach for a tone plan for 20 MHz distribution bandwidth (DBW), according to embodiments. It is noted that in order to keep the tone range within 242-tone RRU, modification of the 106-tone extra padding tones can be performed wherein in addition to 26-tone DRU5, 106-tone DRU2 would not have a 4 times repetition and hence 1×-LTF would not be applicable. It is to be noted that the rest of DRUs defined in FIG. 17 are the same as previously defined in FIG. 14 which illustrated an alternate DRU tone plan for 20 MHz BW, as these DRUs have 4 times repetition and thus 1×-LTF is applicable.

The tone plan illustrated in FIG. 17 includes: one 26-tone DRU (DRU5) with one or seventeen tone spacing between the tones; eight 26-tone DRUs with eight or ten tone spacing between the tones; four 52-tone DRUs, is built from two DRU26, with four or six tone spacing between the tones; and two 106-tone DRUs, built from two DRU52 and 2 extra padding tones. The 106-tone DRU1 has two and four tone spacing everywhere, while, the 106-tone DRU2 has one or five tone spacing around DC tones and two or four tone spacing everywhere else. As would be readily understood, several tones at the centre of the bandwidth are set to zero. These particular tones are not assigned to any RU for both RRU and DRU. It is noted that these particular tones are called DC tones.

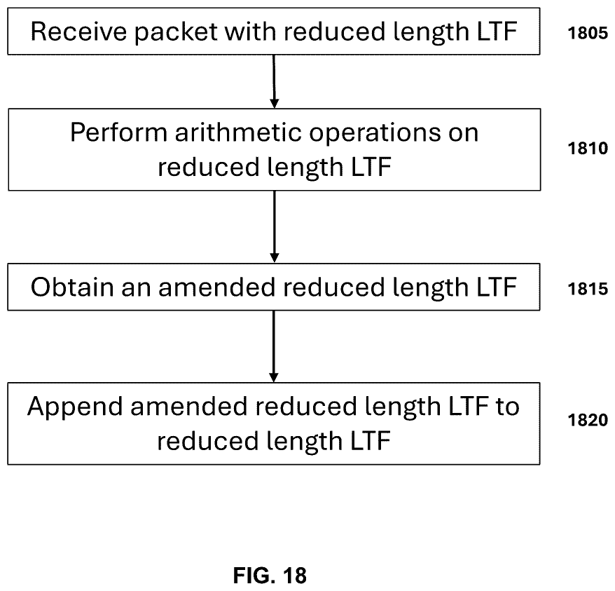

FIG. 18 illustrates a communication method according to embodiments of the present disclosure. The method includes receiving 1805 a packet including a reduced-length long training field (LTF) corresponding to a set of distributed resource units (DRU) tones. Based at least in part on a DRU tone plan, the method further includes performing 1810 one or more arithmetic operations on the reduced-length LTF in order to obtain a complete LTF associated with the reduced-length LTF. According to embodiments, the performing of one or more arithmetic operations on the reduced-length LTF results in obtaining 1815 one or more amended reduced-length LTFs. According to embodiments, the method further includes appending 1820 the one or more amended reduced-length LTFs to the reduced-length LTF to obtain a complete LFT associated with the reduced-length LTF.

### G. Acronyms, Abbreviations, and Definitions of Some Terms

| Full Name | Acronym/Abbreviation/Initialism |
|---|---|
| Distributed Resource Unit | DRU |
| Ultra-High Reliability | UHR |
| Trigger Based | TB |
| PHY Protocol Data Unit | PPDU |
| Long Training Field | LTF |
| Resource Unit | RU |
| Bandwidth | BW |
| High Efficiency | HE |
| Extreme High Throughput | EHT |
| Long Training Sequence | LTS |
| Inverse Discrete Fourier Transform | IDFT |
| Orthogonal Frequency | OFDM |
| Division Multiplex | |
| Mega Hertz | MHz |
| Giga Hertz | GHz |
| Low Power Indoor | LPI |
| Orthogonal Frequency | OFDMA |
| Division Multiple Access | |
| Power Spectral Density | PSD |
| DRU Bandwidth | DBW |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
receiving a packet including a reduced-length long training field (LTF) corresponding to a set of distributed resource units (DRU) tones;
based at least in part on a DRU tone plan, performing one or more arithmetic operations on the reduced-length LTF in order to obtain a complete LTF associated with the reduced-length LTF.

2. The method according to claim 1, wherein performing one or more arithmetic operations on the reduced-length LTF results in obtaining one or more amended reduced-length LTF.

3. The method according to claim 2, further comprises appending the one or more amended reduced-length LTF to the reduced-length LTF to obtain a complete LFT associated with the reduced-length LTF.

4. The method according to claim 1, wherein the one or more arithmetic operations include one or more of: same repetition, mirror repetition, negation and conjugation.

5. The method according to claim 1, wherein the DRU tone plan is associated with 40 MHz and wherein the DRU tone plan includes eighteen 26-tone DRUs, eight 52-tone DRUs, four 106-tone DRUs and two 242-tone DRUs.

6. The method according to claim 5, wherein the DRU tone plan includes eighteen-tone spacing between tones in 26-tone DRUs.

7. The method according to claim 5, wherein the DRU tone plan includes eight or ten tone spacing between tones in 52-tone DRUs.

8. The method according to claim 5, wherein the DRU tone plan includes four or six tone spacing between tones in 106-tone DRUs.

9. The method according to claim 5, wherein the DRU tone plan includes two tone spacing between tones in 242-tone DRUs.

10. The method according to claim 1, wherein the DRU tone plan is associated with 20 MHz and wherein the DRU tone plan includes nine 26-tone DRUs, four 52-tone DRUs, and two 106-tone DRUs.

11. The method according to claim 10, wherein the DRU tone plan includes eight or ten tone spacing between tones in 26-tone DRUs.

12. The method according to claim 10, wherein the DRU tone plan includes four or six tone spacing between tones in 52-tone DRUs.

13. The method according to claim 10, wherein the DRU tone plan includes two or four tone spacing between tones in 106-tone DRUs.

14. The method according to claim 1, wherein the DRU tone plan is associated with 20 MHz, wherein the DRU tone plan includes:
one 26-tone DRU with one or seventeen tone spacing between tones;
eight 26-tone DRUs with eight or ten tone spacing between tones;
four 52-tone DRUs configured from two DRU26 with four or six tone spacing between tones; and
two 106-tone DRUs configured from two DRU52 and 2 extra padding tones.

15. The method according to claim 14, wherein a 106-tone DRU1 includes two and four tone spacing and wherein a 106-tone DRU2 has one or five tone spacing around DC tones and two or four tone spacing elsewhere.

16. One or more circuits for performing a communication method, the method comprising:
receiving a packet including a reduced-length long training field (LTF) corresponding to a set of distributed resource units (DRU) tones;
based at least in part on a DRU tone plan, performing one or more arithmetic operations on the reduced-length LTF in order to obtain a complete LTF associated with the reduced-length LTF.

17. The one or more circuits according to claim 16, wherein the DRU tone plan is associated with 40 MHz and wherein the DRU tone plan includes eighteen 26-tone DRUs, eight 52-tone DRUs, four 106-tone DRUs and two 242-tone DRUs.

18. The one or more circuits according to claim 16, wherein the DRU tone plan is associated with 20 MHz and wherein the DRU tone plan includes nine 26-tone DRUs, four 52-tone DRUs, and two 106-tone DRUs.

19. The one or more circuits according to claim 16, wherein the DRU tone plan is associated with 20 MHz, wherein the DRU tone plan includes:
one 26-tone DRU with one or seventeen tone spacing between tones;
eight 26-tone DRUs with eight or ten tone spacing between tones;
four 52-tone DRUs configured from two DRU26 with four or six tone spacing between tones; and
two 106-tone DRUs configured from two DRU52 and 2 extra padding tones.

20. One or more non-transitory computer-readable storage devices comprising computer-executable instructions, wherein the instructions, when executed, cause one or more circuits to perform a communication method, the method comprising:
receiving a packet including a reduced-length long training field (LTF) corresponding to a set of distributed resource units (DRU) tones;
based at least in part on a DRU tone plan, performing one or more arithmetic operations on the reduced-length LTF in order to obtain a complete LTF associated with the reduced-length LTF.

21. The one or more non-transitory computer-readable storage devices according to claim 20, wherein the DRU tone plan is associated with 40 MHz and wherein the DRU tone plan includes eighteen 26-tone DRUs, eight 52-tone DRUs, four 106-tone DRUs and two 242-tone DRUs.

22. The one or more non-transitory computer-readable storage devices according to claim 20, wherein the DRU tone plan is associated with 20 MHz and wherein the DRU tone plan includes nine 26-tone DRUs, four 52-tone DRUs, and two 106-tone DRUs.

23. The one or more non-transitory computer-readable storage devices according to claim 20, wherein the DRU tone plan is associated with 20 MHz, wherein the DRU tone plan includes:
one 26-tone DRU with one or seventeen tone spacing between tones;
eight 26-tone DRUs with eight or ten tone spacing between tones;
four 52-tone DRUs configured from two DRU26 with four or six tone spacing between tones; and
two 106-tone DRUs configured from two DRU52 and 2 extra padding tones.
